(19) United States
(12) Patent Application Publication
(10) Pub. No.: US 2007/0206338 A1
(43) Pub. Date: Sep. 6, 2007

(54) Circuit Protection Method, Protection Circuit and Power Supply Device Using The Protection Circuit

(76) Inventor: Tsutomu Ishino, Kyoto (JP)

Correspondence Address: CANTOR COLBURN, LLP, 55 GRIFFIN ROAD SOUTH, BLOOMFIELD, CT, 06002, US

(21) Appl. No.: 11/659,780

(22) PCT Filed: Jul. 7, 2005
(86) PCT No.: PCT/JP05/12551

§ 371 Date: Feb. 8, 2007

(30) Foreign Application Priority Data
Aug. 10, 2004 (JP) 2004-233402

(51) Int. Cl. H02H 9/02

(52) U.S. Cl. 361/93.9

(57) ABSTRACT

An excess current protection circuit which can change a limited current corresponding to an output voltage by simple constitution. A power supply device (100) is provided with a regulator (10), which regulates the output voltage to be constant based on a reference voltage, and an excess current protection circuit (20). The regulator (10) is a general three-terminal regulator which includes an output transistor (14), an error amplifier (12) and resistors (R1, R2). The excess current protection circuit (20) detects an output current (lout) by a first transistor (M1), and converts it into a voltage by a variable resistor (Rvar). A voltage comparator (24) compares the voltage with a threshold voltage (Vth) corresponding to a limited current and detects an excess current status. A current adjusting circuit (26) drops driving performance of the regulator (10) when the excess current status is detected, and protects the circuit. The resistance value of the variable resistor (Rvar) is set based on an output voltage (Vout), and a value of the limited current is changed corresponding to the output voltage.

### BACKGROUND OF THE INVENTION

1. Field of the Invention

The present invention relates to a protection circuit, and more particularly, relates to an overcurrent protection technology of a circuit.

2. Description of the Related Art

In regulators or the like which stabilize voltages, Power MOSFETs (Metal Oxide Semiconductor Field Effect Transistors), IGBTs (Insulated Gate Bipolar Transistors) and Bipolar Power Transistors are, for example, provided as output transistor. These transistors are designed to have a sufficient margin with respect to an ordinal operating current, in the form of the maximum allowable current.

However, even when designed to have a sufficient design margin like this, a large overcurrent exceeding the maximum allowable current will flow in the output transistor in case when an output load circuit is short-circuited or the like, causing a problem in that the reliability of the transistor is affected. In addition, even when a current is below the maximum allowable current of an output transistor, a current limitation is desired in order to protect a load circuit connected to the regulator.

Therefore, a regulator is conventionally provided with a protection circuit having the function of limiting current in order to protect a transistor from an overcurrent, or to limit the current flowing into a load circuit. (See Patent documents 1 and 2.)

Patent Document 1: JP Patent Application Laid-open No. 2002-196830.

Patent Document 2: JP Patent Application Laid-open No. Hei 2-109110.

If an output current flowing into an output transistor is limited to the limit current Ilim by a protection circuit, the power consumption P which is consumed in the output transistor is given by the equation P=(Vin−Vout)×Ilim, using the input voltage Vin and the output voltage Vout. If the input voltage Vin is constant and the output voltage Vout becomes low when the circuit is overloaded or short-circuited, then the power P consumed in the output transistor increases. The power consumption P becomes heat, which might affect the reliability of the circuit, therefore, it is desirable to decrease the power consumption P. If the relation between the output current Iout and the output voltage Vout of the regulator is as illustrated in FIG. 3 of each of the Patent documents 1 and 2, then, the power consumption in the output transistor increases as the output voltage Vout decreases, according to the above relation.

Therefore, as shown in FIG. 4 of the Patent Document 1or in FIG. 1 of the Patent Document 2, it is desirable to change the limit current in accordance with the output voltage Vout, setting the limit current Ilim to a lower value according as the output voltage Vout decreases.

### SUMMARY OF THE INVENTION

The present invention is made in view of these problems, and the general purpose of the invention is to provide an overcurrent protection circuit with a simple structure which can change the limit current in accordance with the output voltage.

An embodiment of the invention relates to the method for protecting a circuit. This method compares the current corresponding to the output current of the circuit to be protected with the predetermined reference current after converting the currents into voltages respectively, to decrease the driving capability of the circuit to be protected when the current corresponding to the output current is larger than the other, and to set the reference current to a lower value when the output voltage of the circuit to be protected is lower than the predetermined voltage.

According to the embodiment, since it is possible to decrease the output current when the output voltage of the circuit to be protected is lower, the power consumption in the circuit to be protected can be preferably decreased, and the load circuit can be protected as well.

Another embodiment of the invention relates to a protection circuit. This protection circuit includes a current generating circuit which generates a detection current corresponding to the output current of the circuit to be protected; a variable resistance circuit with the voltage at its one end fixed which is provided on the path of the detection current generated by the current generating circuit; an auxiliary circuit which decreases the driving capability of the circuit to be protected when the voltage dropped by the variable resistance circuit is larger than the predetermined reference voltage. The variable resistance circuit is configured to have a higher resistance when the output voltage of the circuit to be protected is lower than the predetermined voltage.

The protection circuit converts the detection current corresponding to the output current into the voltage by flowing the current into the variable resistance circuit, and detects the state of overcurrent in comparison with the predetermined reference voltage corresponding to the limit current. Here, the current “corresponding to the output current” means the current which is associated with the output current, including such a case in which the output current is proportional to the detection current.

According to the embodiment, by changing the resistance value of the variable resistance circuit which converts a current into a voltage, the voltage dropped changes, and since the relation with the reference voltage varies relatively, it is possible to change the value of the limit current in accordance with the output voltage. As a result, the output current can be decreased when the output voltage of the circuit to be protected is lower, which can preferably decrease the power consumption of the circuit to be protected when overloaded or short-circuited.

The variable resistance circuit may be configured to have a higher resistance when the output voltage of the circuit to be protected is lower than the predetermined voltage after the output current of the circuit to be protected exceeds the predetermined value.

In case when it is not desirable to set the value of the limit current to a lower value before the output voltage of the circuit to be protected starts up, after waiting for the output current to exceed the predetermined value, the limit current may be set to a lower value when the output voltage is lower than the predetermined voltage thereafter.

The auxiliary circuit may include a transistor of which control terminal the voltage dropped by the variable resistance circuit is impressed on, and may decrease the driving capability of the circuit to be protected when the transistor turns on, after the voltage dropped by the variable resistance circuit is larger than the threshold voltage of the transistor.

“A control terminal of the transistor” means a gate terminal in the MOSFET and a base terminal in the bipolar transistor. The comparison in magnitude between the output current and the limit current can be achieved by impressing the voltage dropped by the variable resistance circuit on a point between the gate sources or the base emitters of a transistor, and by corresponding the threshold voltage of the transistor start-up to the reference voltage.

The variable resistance circuit may include a first and a second resistors which are connected together in series; and a bypass transistor which is connected in parallel with the second resistor and is impressed with the voltage corresponding to the output voltage of the circuit to be protected on its control terminal.

When the bypass transistor turns off, the resistance value is higher because the first and the second resistors are connected together in series, whereas the resistance value of the variable resistance circuit is lower because the second resistor is bypassed due to the bypass transistor turning on.

Another embodiment of the present invention elates to a power supply apparatus. The power supply apparatus includes a regulator circuit having an output transistor, and a protection circuit which detects that the current flowing into the output transistor is in the state of overcurrent and decreases the driving capability of the output transistor. The protection circuit includes the first transistor which is provided in parallel with the output transistor and generates the detection current corresponding to the output current of the regulator circuit; a variable resistance circuit with the voltage at its one end fixed which is provided on the path of the detection current generated by the first transistor; an auxiliary circuit which forces the voltage of the control terminal of the output transistor to change in the direction in which the driving capability decreases when the voltage dropped by the variable resistance circuit is larger than the predetermined reference voltage.

According to the embodiment, when the state of overcurrent is detected by the protection circuit, it is possible to decrease the driving capability of the output transistor and to protect the power supply apparatus by forcing the voltage between the gate sources or the base emitters of the output transistor in the regulator circuit to decrease.

The regulator circuit includes an output transistor which is provided between the input terminal and the output terminal, and an error amplifier which adjusts the voltage of the control terminal in the output transistor so that the output voltage appearing at the output terminal will approximate the desired voltage value, wherein the auxiliary circuit may include a second transistor with its one end connected to the control terminal of the output transistor, which turns on when the voltage dropped by the variable resistance circuit exceeds the threshold voltage, forcing the voltage of the control terminal in the output transistor to change.

According to the embodiment, when the state of overcurrent is detected, by turning on the second transistor provided between the gate sources or base emitters of the output transistor in the regulator circuit, the voltage between the gate sources or the base emitters is short-circuited, and the driving capability of the output transistor is decreased to protect the power supply apparatus.

The power supply apparatus may further includes the PNP bipolar transistor connected between the first transistor and the variable resistance circuit; and the NPN bipolar transistor provided between the base terminal of the PNP bipolar transistor and the input terminal, and the base terminal of the NPN bipolar transistor may be impressed with the output voltage.

Since the both voltages between the base emitters in the two bipolar transistors are nearly equal, the emitter terminal of the PNP bipolar transistor is fixed at the value close to the output voltage. As a result, since all of the three terminals of the first transistor and the output transistor are impressed with almost equal voltages thereon, the first transistor can accurately detect the current flowing into the output transistor.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram showing the structure of the power supply apparatus according to the embodiment of the present invention.

FIGS. 2A-2C show the relations among the output voltage, the variable resistance value, the limit current and the output current.

FIG. 3 is a circuit diagram showing the structure of the power supply apparatus to limit the current, shown in FIG. 2C.

FIG. 4 shows a variaton of the power supply apparatus of FIG. 3.

FIG. 5 shows another variation of the power supply apparatus of FIG. 3.

FIG. 6 is a block diagram showing the structure of an electronic device in which the power supply apparatus of FIG. 1 is mounted.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

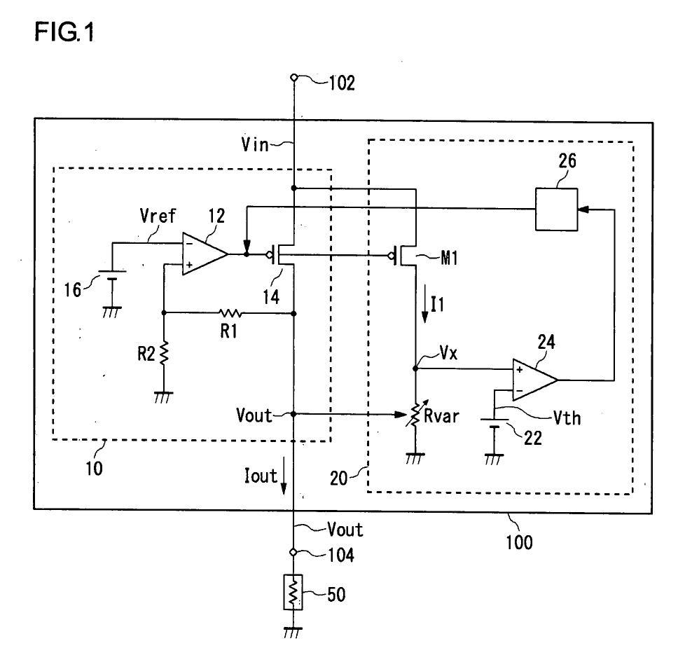

FIG. 1 is a circuit diagram showing a power supply apparatus 100 according to an embodiment of the present invention. In the accompanying drawings, the same constituting elements shall be denoted by the same reference symbols, and explanations will be omitted appropriately.

The power supply apparatus 100 includes a regulator 10 which adjusts the output voltage to a constant value based on the reference voltage, and an overcurrent protection circuit 20. The overcurrent protection circuit 20 detects the state of overcurrent in the regulator 10, and decreases the driving capability of the regulator when the circuit is overloaded or the load is short-circuited.

The power supply apparatus 100 is integrated on a semiconductor substrate, and includes the input terminal 102 and the output terminal 104. The voltage impressed on the input terminal 102 and the voltage that appear at the output terminal 104 are referred to as the input voltage Vin and the output voltage Vout, respectively. The load circuit 50 is connected to the output terminal 104 of the power supply apparatus 100, and the current which flows into the load circuit 50 via the output terminal 104 is called the output current Iout.

The regulator 10 is a general three-terminal regulator, including the error amplifier 12, the output transistor 14, the reference voltage source 16, the first resistor R1, and the second resistor R2. The regulator 10 keeps the output voltage Vout of the output terminal 104 at a constant level, based on the reference voltage Vref generated by the reference voltage source 16. In the following description, the reference numerals to denote voltage signals, current signals or resistors are also used as needed to represent voltage values, current values or resistance values, respectively.

At the inverting input terminal of the error amplifier 12, the reference voltage Vref generated by the reference voltage source 16 is input. In addition, the output voltage Vout which is resistively divided by the first and the second resistors R1 and R2, and multiplied by R2/(R1+R2), is feedback input to the non-inverting input terminal.

The output transistor 14 is a pMOSFET in which the source terminal is the input terminal 102 of the power supply apparatus 100 and the drain terminal is the output terminal 104 of the power supply apparatus 100. In addition, the gate terminal corresponds to the control terminal and is connected to the output of the error amplifier 12.

The error amplifier 12 adjusts the gate voltage of the output transistor 14 so that the both voltages input to the non-inverting input terminal and the inverting input terminal are equal to each other. Consequently, the output voltage Vout is stabilized so that the equation of Vout=Vref×(R1+R2)/R2 will hold.

The overcurrent protection circuit 20 includes the first transistor M1, the variable resistor Rvar, the threshold voltage source 22, the voltage comparator 24, and the current adjusting circuit 26. The overcurrent protection circuit 20 decrease the driving capability of the regulator 10 to protect the circuit, when the output current Iout reaches the predetermined limit current Ilim.

The first transistor M1 is provided in parallel with the output transistor 14 of the regulator 10 so that the gate voltage and the source voltage will be shared, and the current capability is set to a lower level than that of the output transistor 14. The detection current I1 flowing in the first transistor M1 depends on the size ratio of the output transistor 14 and the first transistor M1. When the size ratio of the first transistor M1 and the output transistor 14 is S1, the relation of I1=Iout/ Si will hold between the detection current I1 and the output current Iout. In other words, the first transistor M1 has the function to generate the detection current I1 corresponding to the output current Iout.

The variable resistor Rvar is provided between the drain terminal of the first transistor M1 and the ground, and converts the detection current Ii into voltage. The voltage dropped in the variable resistor Rvar, that is, the detection voltage Vx appearing in the variable resistor Rvar is considered the voltage value into which the output current Iout flowing into the output transistor 14 is converted. Between the detection voltage Vx and the output current Iout, the relation of Vx=I1×Rvar=Iout/S1×Rvar holds.

The threshold voltage source 22 generates the threshold voltage Vth. Since the threshold voltage Vth is the voltage which is to be compared with the detection voltage Vx, the voltage corresponds to the voltage which determines the limit current Ilim in the overcurrent protection circuit 20. When Vth<Vx, it is determined that overcurrent occurs; consequently, the threshold voltage Vth and the limit current Ilim hold the relation of Vth=Ilim/S1×Rvar.

The detection voltage Vx is input into the non-inverting input terminal of the voltage comparator 24, and the threshold voltage Vth is input into the inverting input terminal. The voltage comparator 24 compares the detection voltage Vx corresponding to the output current Iout with the threshold voltage Vth corresponding to the limit current Ilim of the overcurrent protection circuit 20, and when Vth<Vx, the voltage comparator 24 determines that the state of overcurrent occurs.

The current adjusting circuit 26 has the function to decrease the driving capability of the regulator 10, when Vx>Vt in the voltage comparator 24 and it is determined that overcurrent occurs. The driving capability of the regulator 10 depends on the gate-source voltage Vgs of the output transistor 14. It is necessary for the gate-source voltage Vgs to be decreased to decrease the driving capability. Therefore, in the state of overcurrent, the current adjusting circuit 26 decreases the driving capability of the protection targeted regulator 10, that is, the output current, and realizes the protection of the circuit, by forcing the gate voltage of the output transistor 14 to be raised.

The resistance value of the variable resistor Rvar is determined, depending on the output voltage Vout. Since the limit current Ilim is given by Ilim=S1×Vth/Rvar, it is possible to change the limit current Ilim by changing the resistance value of the variable resistor Rvar.

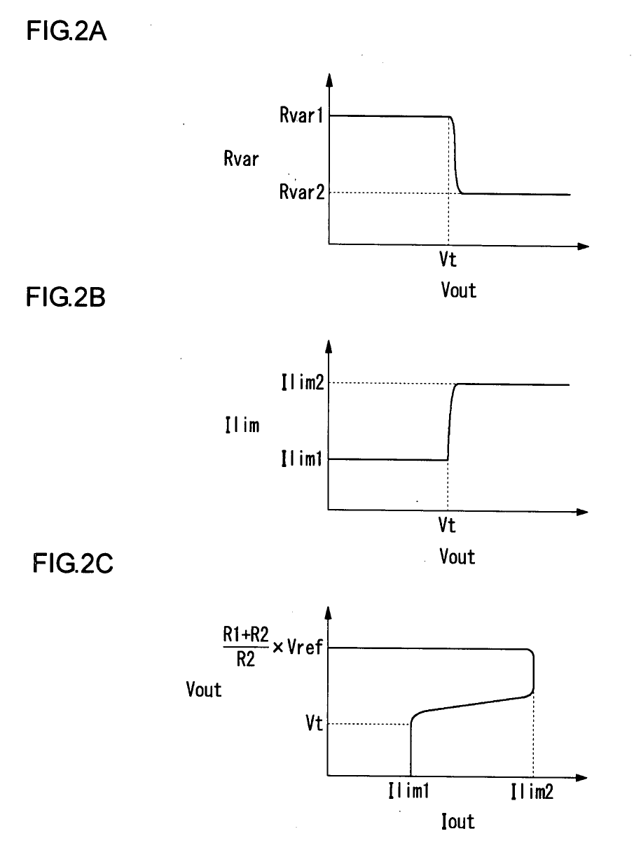

FIG. 2A shows the relation between the resistance value of the variable resistor Rvar and the output voltage Vout. FIG. 2B shows the relation between the output voltage Vout and the limit current Ilim, when the relation shown in the FIG. 2A holds. FIG. 2C shows the relation between the output voltage Vout and the output current Iout that occurs when the relation shown in the FIGS. 2A and 2B holds. In the ordinary operations, the output voltage Vout is stabilized at the value of (R1+R2)/R2×Vref, using the reference voltage Vref. When the output current Iout reaches Ilim2, the gate voltage of the output transistor 14 is forced to be raised so that current limitation is effected, which results in the characteristic curve with the shape of the numeral “2” with the base thereof truncated, as shown in FIG. 2C.

If the output voltage Vout drops below the threshold voltage Vt as a result of the failure of the regulator 10 to maintain a constant output voltage Vout due to an overloaded state or a short-circuited load, then the output current Iout is limited by the limit current Ilim to decrease the power consumption at the output transistor 14.

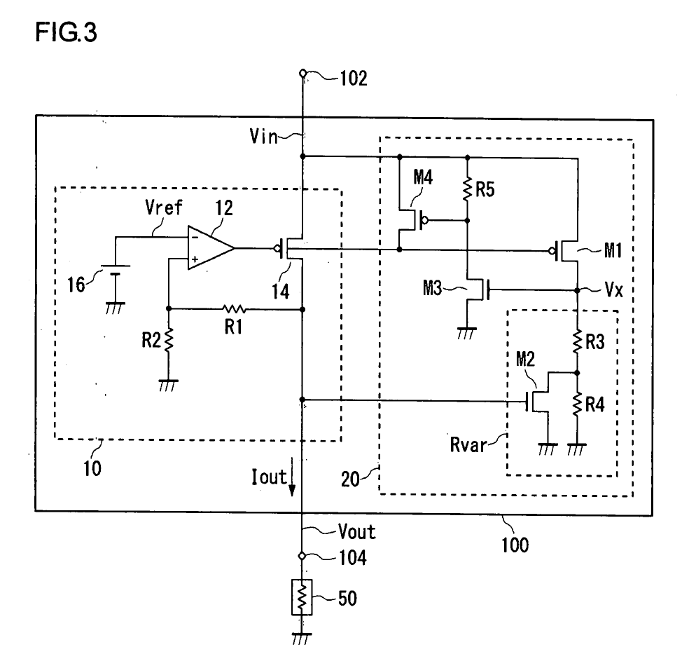

FIG. 3 shows the structure of the power supply apparatus 100 in which the overcurrent protection circuit 20 to perform the current limitation shown in FIG. 2C is illustrated in detail.

In this power supply apparatus 100, the overcurrent protection circuit 20 includes the first transistor M1, the variable resistor Rvar, the third transistor M3, the fourth transistor M4, and the fifth resistor R5.

The variable resistor Rvar includes the third resistor R3, the fourth resistor R4, and the bypass transistor M2. The output terminal 104 of the regulator 10 is connected to the gate terminal of the bypass transistor M2, and the output voltage Vout is impressed.

When the output voltage Vout is higher than the gate threshold voltage Vt2 of the bypass transistor M2, the bypass transistor M2 turns on, and the fourth resistor R4 is bypassed. Therefore, the resistance value of the variable resistor Rvar is about R3. When the output voltage Vout is low, and when Vout<Vt2, the bypass transistor M2 turns off and the resistance value of the variable resistor Rvar is set as high as R3+R4. Thus, the resistance value of the variable resistor Rvar can be dependent on the output voltage shown in FIG. 2A. In FIG. 2A, both relations of Rvar1=R3+R4 and Rvar2=R3 hold. Further, the gate threshold voltage Vt2 of the bypass transistor M2 is Vt in FIG. 2.

The gate terminal of the third transistor M3 is impressed with the voltage Vx corresponding to the voltage dropped in the variable resistor Rvar. If the gate threshold voltage of the third transistor M3 is Vt3, and when Vx>Vt3, the third transistor M3 turns on. If Vx<Vt3, the third transistor turns off. That is, in the power supply apparatus 100 of FIG. 3, the status of overcurrent is detected in response to the on/off of the third transistor M3, and the third transistor M3 performs the function of the voltage comparator 24 in FIG. 1. Also, the gate threshold voltage Vt3 corresponds to the threshold voltage Vth in FIG. 1.

When the resistance value of the variable resistor Rvar is R3 or R3+R4, the limit current Ilim can be obtained as follows. The voltage dropped Vx in the variable resistor Rvar is given by the equation of Vx=Iout/S1×Rvar using the output current Iout. Since the output current Iout is the limit current Ilim when the voltage dropped Vx is equal to the gate threshold voltage Vt3 of the third transistor M3, and since Vt3=Ilim/S1×Rvar, the equation of Ilim=Vt3×S1/Rvar is established. Accordingly, when Rvar=R3+R4, Ilim1=Vt3×S1/(R3+R4) is established. Also, when Rvar=R3, Ilim2=Vt3×S1/R3 is established. Therefore, the values of Ilim1 and Ilim2 in FIG. 2B can be adjusted with the resistance values of the third resistor R3 and the fourth resistor R4.

When the voltage dropped Vx in the variable resistor Rvar increases and the third transistor M3 turns on, a current flows into the fifth resistor R5. When the voltage dropped in the fifth resistor R5 is higher than the gate threshold voltage Vt4 of the fourth transistor M4, the fourth transistor M4 turns on, causing the voltages between the source drains to be nearly equal, and the gate voltage of the output transistor 14 is nearly equal to the input voltage Vin to decrease the driving capability of the output transistor 14. That is, the fourth transistor M4 and the fifth resistor R5 perform the function of the current adjusting circuit 26 in FIG. 1.

In the power supply apparatus 100 structured as described above, and shown in FIG. 3, the resistance value of the variable resistor R3 is dependent on the output voltage as shown in FIG. 2A. Also, the threshold value Vt in FIG. 2B corresponds to the gate threshold voltage Vt2 of the bypass transistor M2. When Vout<Vt2, the output current value is limited by Ilim1, whereas when Vout>Vts, limited by Ilim2, therefore, overcurrent protections can be properly achieved in accordance with the output voltage Vout.

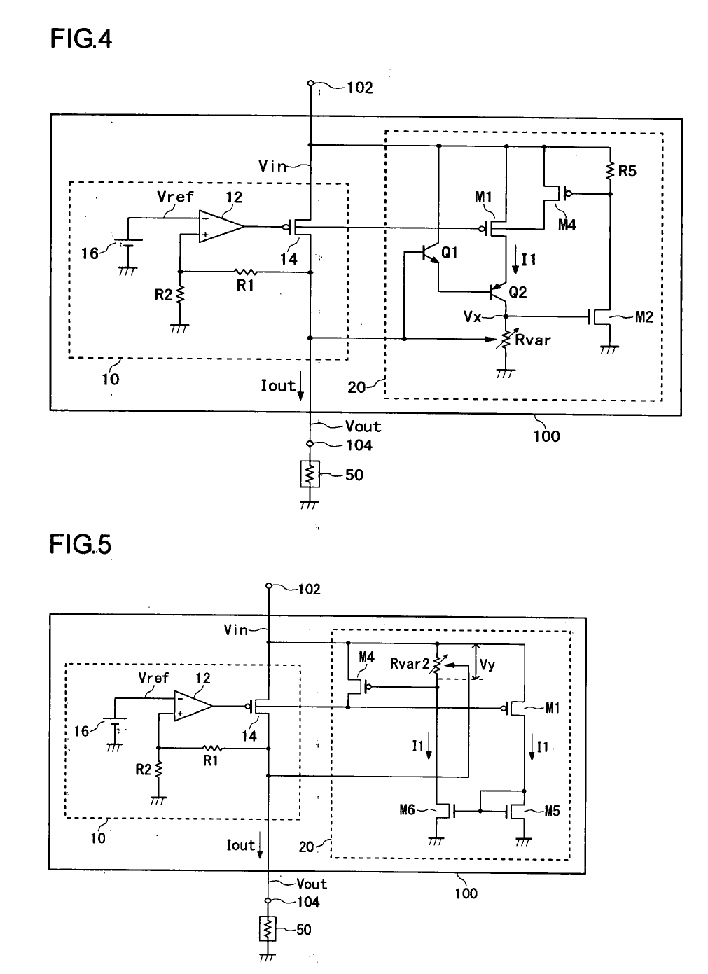

FIG. 4 shows a modification example of the power supply apparatus 100 shown in FIG. 3. The overcurrent protection circuit 20 includes the NPN bipolar transistor Q1 and the PNP bipolar transistor Q2, in addition to the constituting elements of the FIG. 3. The bipolar transistors Q1 and Q2 are provided so that the detection current I1 accurately corresponding to the output current Iout will be generated by the first transistor M1.

In the current-voltage characteristic (Ids-Vds characteristic) of the ideal MOSFET, the drain current Ids in the saturation region holds a constant value independent of the drain-source voltage Vds. However, in a real MOSFET, Ids is not a constant value, changing dependently on Vds. In FIG. 3, the drain terminal of the first transistor M1 was the voltage dropped Vx in the variable resistor Rvar. Since the voltage dropped Vx changes because of the resistance value of the variable resistor Rvar and the detection current I1, the voltage dropped Vx is not always equal to the output voltage Vout. In other words, in the output transistor 14 and the first transistor M1, the voltages between the gate and the source are equal, however, the voltages between the drain and the source are not always equal, therefore, the current values corresponding to the output current Iout generated by the first transistor M1 often vary. The bipolar transistors Q1 and Q2 are provided to solve the problem.

The base terminal of the bipolar transistor Q1 is impressed with the output voltage Vout, and the emitter terminal is connected to the base terminal of the bipolar transistor Q2. Since the voltages between the base emitters of the two bipolar transistors are both about 0.7 V, the voltage of the drain terminal in the first transistor M1 is nearly equal to the output voltage Vout. As a result, the first transistor M1 and the output transistor 14 are impressed with the almost equal voltages on their respective three terminals of the gate, source, and drain terminal. Consequently, the first transistor M1 can accurately generate the detection current I1 corresponding to the output current Iout to be able to perform more stable overcurrent protections.

FIG. 5 shows another modification example of the power supply apparatus 100. The overcurrent protection circuit 20 of the power supply apparatus 100 includes the first transistor M1, the fourth transistor M4, the fifth transistor M5, the sixth transistor M6, and the variable resistor Rvar2.

The fifth and the sixth transistors M5 and M6 constitute the current mirror circuit, and the detection current I1 corresponding to the output voltage Iout generated by the first transistor M1 flows in the variable resistor Rvar2. Accordingly, the voltage dropped Vy in the variable resistor Rvar2 is given by the equation of Vy=I1×Rvar2. As the output current Iout, that is, the detection current I1 becomes larger, the voltage dropped Vy increases. When the voltage dropped Vy is larger than the gate threshold voltage Vt of the fourth transistor M4, the fourth transistor M4 turns on, and the gate voltage of the output transistor 14 is forced to be brought close to the source voltage causing the driving capability to be decreased, and the overcurrent protection circuit starts.

The voltage dropped Vy in the variable resistor Rvar2 is given by the equation of Vy=Rvar2×I1=Rvar/S1×Iout. Accordingly, the limit current Ilim in the overcurrent protection circuit 20 is given by the equation of Ilim=Vt4×S1/Rvar2 using the gate threshold voltage Vt4 of the fourth transistor M4. The resistance value of the variable resistor Rvar2 is changed by the output voltage Vout so that the limit current Ilim can be dependent on the output voltage Vout, and the current-voltage characteristics shown in the FIG. 2C can be obtained.

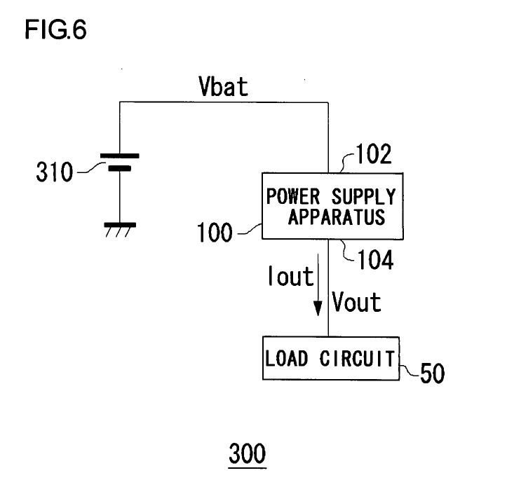

FIG. 6 is a block diagram illustrating the structure of the electronic device 300 in which the power supply apparatus 100 shown in FIG. 1 or FIG. 3 through FIG. 5 is mounted. The electronic device 300 is a battery-powered, mall-sized information terminal such as, for example, a terminal of a mobile phone, PDA (Personal Digital Assistance), or a CD player, and includes the battery 310, the power supply apparatus 100, and the load circuit 50. The battery 310 is, for example, an lithium-ion battery outputting the battery voltage Vbat of about 3 to 4V. Of circuit blocks used in the electronic device 300, the load circuit 50 is a circuit which always should be provided with the constant power supply voltage, and corresponds to, for example, a digital IC which requires the battery voltage of Vdd=3V, or an analogue IC or the like. The power supply apparatus 100 stabilizes the battery voltage Vbat output from the battery 310, and provides the battery voltage Vdd of about 3V to the load circuit 50.

When an overcurrent is introduced in the power supply apparatus 100 caused by a short circuit of the load circuit 50 or the like, the circuit protection shown in FIGS. 2A through 2C starts working to preferably protect the power supply apparatus 100 and the load circuit 50, due to the overcurrent protection circuit 20.

Above embodiments are only exemplary, and it can be understood to a person skilled in the art that various modifications are possible in combinations of those each constituting element and each process, and that such modifications are also within the scope of the present invention.

In the present embodiments, an overcurrent protection circuit is applied to a three-terminal linear regulator, and by forcing the voltage to be changed with the output of the current adjusting circuit 26 connected to the gate terminal of the output transistor 14, the driving capability is decreased, however, it is not limited to this. If the gate voltage of the output transistor 14 can be changed, other measures may be adopted, for example, the measure of changing the output of the error amplifier 12 after connecting the output of the current adjusting circuit 26 to the error amplifier 12.

The present embodiments are described about the case of applying an overcurrent protection circuit to a three-terminal linear regulator, however, it is not limited to this. The circuit to be protected may be a power supply apparatus such as a switching regulator or a switched capacitor type DC/DC converter or the like. In this case, when the overcurrent protection circuit detects a state of overcurrent, a feedback to decrease the driving capability may be provided to the PWM control circuit. In other words, the overcurrent protection circuit associated with the present invention can be applied to the whole use of limiting the output current.

FIG. 3 illustrates the variable resistor Rvar constituted from two resistors, however, it may be possible that more resistors are connected in series and more resistors are to be changed by bypassing each resistor in accordance with the output voltage. In this case, in FIG. 3, overcurrent protections can be conducted more preferably, since the limit current Ilim is set finely in accordance with the output voltage Vout.

Also, combinations of resistors and transistors, such as connecting the third resistor R3 and the bypass-transistor M2 in series to be followed by connecting these to the fourth resistor R4 in parallel, may be practiced in various modifications. The bypass-transistor may be properly subject to on/off by shifting the level of the output voltage Vout, and so on.

Also, the way to detect the output current Iout may be replaced by, for example, a method in which after connecting the detection resistor to the output transistor 14 in series, the voltage dropped in the detection resistor is monitored.

The present embodiments illustrate a MOSFET as examples of the output transistor 14 or the transistor M1 through M6. However, other types of transistors such as a bipolar transistor may be used, and the selection of transistors may be determined according to the design specifications required for the power supply apparatus 100, or the semiconductor manufacturing process in use, or the like.

In the present embodiments, elements constituting the power supply apparatus 100 may be integrated as one body, or may be incorporated into a plurality of LSIs, further, some of the elements may be implemented as discrete parts. It may be determined which parts to be integrated according To the cost and the area utilized, or the like.

While the preferred embodiments of the present invention have been described using specific terms, such description is for illustrative purposes only, and it is to be understood that changes and variations may be made without departing from the spirit or scope of the appended claims.

1. A method for protecting a circuit, comprising:
comparing a current corresponding to an output current of the circuit to be protected with a predetermined reference current after converting the currents into voltages respectively;
decreasing a driving capability of the circuit to be protected when the current corresponding to the output current is larger than the other; and
setting the reference current to a lower value when an output voltage of the circuit to be protected is lower than a predetermined voltage.

2. A protection circuit, comprising:
a current generating circuit which generates a detection current corresponding to an output current of a circuit to be protected;
a variable resistance circuit with a voltage at its one end fixed which is provided on the path of the detection current generated by the current generating circuit; and
an auxiliary circuit which decreases the driving capability of the circuit to be protected when a voltage drop across the variable resistance circuit is larger than a predetermined reference voltage, wherein the variable resistance circuit is configured to have a higher resistance when the output voltage of the circuit to be protected is lower than the predetermined voltage.

3. The protection circuit according to claim 2, wherein the variable resistance circuit is configured to have a higher resistance when the output voltage of the circuit to be protected is lower than the predetermined voltage after the output current of the circuit to be protected exceeds a predetermined value.

4. The protection circuit according to claim 2, wherein the auxiliary circuit includes a transistor in which the voltage drop across the variable resistance circuit is applied to a control terminal thereof, and decreases driving capability of the circuit to be protected when the voltage drop across the variable resistance circuit is larger than the threshold voltage of the transistor and the transistor turns on.

5. The protection circuit according to claim 2, wherein the variable resistance circuit comprises
a first and a second resistors which are connected in series; and
a bypass transistor connected in parallel with the second resistor, in which the voltage corresponding to the output voltage of the circuit to be protected is applied to the control terminal thereof.

6. A power supply apparatus, comprising:
a regulator circuit having an output transistor; and
a protection circuit which detects that a current flowing into the output transistor is in the state of overcurrent and decreases driving capability of the output transistor, wherein the protection circuit comprises:
a first transistor which is provided in parallel with the output transistor and generates the detection current corresponding to the output current of the regulator circuit;
a variable resistance circuit with the voltage at its one end fixed which is provided on the path of the detection current generated by the first transistor; and
an auxiliary circuit which forces the voltage of the control terminal of the output transistor to change in the direction in which the driving capability decreases when the voltage drop across the variable resistance circuit is larger than a predetermined reference voltage, and wherein the variable resistance circuit is configured to have a higher resistance when the output voltage of the regulator circuit is lower than the predetermined voltage.

7. The power supply apparatus according to claim 6,
wherein, the regulator circuit comprises:
an output transistor which is provided between an input terminal and an output terminal;
an error amplifier which adjusts the voltage of the control terminal in the output transistor so that the output voltage appearing at the output terminal will approximate the desired voltage value, wherein the auxiliary circuit includes
a second transistor with its one end connected to the control terminal of the output transistor, which turns on when the voltage dropped by the variable resistance circuit exceeds the threshold voltage, forcing the voltage of the control terminal in the output transistor to change.

8. The power supply apparatus according to claim 6, further comprising:
a PNP bipolar transistor connected between the first transistor and the variable resistance circuit; and
a NPN bipolar transistor connected between the base terminal of the PNP bipolar transistor and the input terminal,
wherein the base terminal of the NPN bipolar transistor is impressed with the output voltage.

9. The power supply apparatus according to claim 6, wherein the power supply apparatus is integrated as one body on a semiconductor substrate.

10. An electronic device, comprising;
a battery; and
a power supply apparatus according to claim 6 which stabilizes the voltage of the battery to provide the battery to a load circuit.
